(19) United States
(12) Patent Application Publication
(10) Pub. No.: US 2011/0240209 A1
(43) Pub. Date: Oct. 6, 2011

(54) BAMBOO-SURFACED LAMINATED LOUVER CURTAIN SLAT AND A METHOD OF MANUFACTURING THE SAME

(76) Inventor: Yuqiang Chen, Hu Zhou (CN)

(21) Appl. No.: 13/156,198

(22) Filed: Jun. 8, 2011

Related U.S. Application Data
(63) Continuation of application No. 12/353,356, filed on Jan. 14, 2009.
Application No. 12/353,356 is a continuation of application No. PCT/CN2007/070304, filed on Jul. 16, 2007.

(30) Foreign Application Priority Data
Jul. 17, 2006 (CN) 200610052485.4
Aug. 18, 2006 (CN) 200610053006.0

(51) Int. Cl. B32B 38/10; B32B 38/04

(52) U.S. Cl. 156/152; 156/211; 156/256

(57) ABSTRACT

A bamboo-surfaced laminated louver curtain slat and a method of manufacturing the same. The bamboo-surfaced laminated louver curtain slat comprises two peeled bamboo veneer layers (21,22) and at least one filler layer (23) sandwiched between the two bamboo veneer layers. The peeled bamboo veneer layers and the filler layer(s) are bond together in a glued manner. The production method comprises follow steps: thin peeled bamboo veneer layers are peeled from a massive bamboo board and after being cut into a specified width, the peeled bamboo veneer layers, together with filler material, are put into moulds for hot-pressing and gluing; or thin peeled bamboo veneer layers are peeled from a massive bamboo board made by gluing and pressing bamboo material, a first peeled bamboo veneer layer, filler material, and a second peeled bamboo veneer layer are glued and press-formed in sequence into a piece of ply-bamboo, then, laminated louver curtain slats of a specified width are cut from the ply-bamboo. The method of the invention is simple and easy to practice and material-saving, and it improves the variety of louver curtains.

### CROSS-REFERENCE TO RELATED APPLICATIONS

This application is a Continuation of application Ser. No. 12/353,356, filed Jan. 14, 2009, which is a U.S. National Stage of PCT/CN2007/070304, filed Jul. 16, 2007, which applications are incorporated herein by reference.

### FIELD OF THE INVENTION

This invention relates to technique for manufacturing a slat of louver-type curtains, more particularly, to a bamboo-surfaced laminated louver curtain slat and a method of manufacturing the same.

### BACKGROUND OF THE INVENTION

Louver-type curtains are commonly used curtains for keeping out sunlight. They have advantages of being convenient to use and aesthetics in appearance, and so they are a favorite choice for many people. Existing louver curtain slats are generally made directly of plastics, wood or bamboo. Among them, plastic louver curtain slats are limited to some extent in use, because they have a short service life and are difficult to be treated and degraded after being disused, and other treating processes are harmful to the environment more or less. In the case of louver curtain slats made of wood and bamboo, they are made by conventional saw-cutting process, during which a considerable volume of material is wasted due to the thickness of a saw blade, thus leading to a quite low material utilization rate. Moreover, raw materials of wood or bamboo used for direct saw-cutting of louver curtain flats must meet some requirements in dimensions. Thus, in selecting, quite a lot of raw material are rejected because of their unqualified thickness, width or length, thus leading to high material waste. Accordingly, there is a need to develop a new method for manufacturing louver curtain slats which is material-saving and environment-friendly.

The bamboo slats of louver curtains disclosed in Chinese Utility Model No. 98250307.5 and Chinese Invention Patent Application No. 98125685.6 and No. 01130009.4 have a structure in which bamboo material is arranged transversely on a surface side by side. The manufacture method includes the following steps: first, arranging bamboo sheets and wood sheets of certain dimensions alternately, pressing and bonding them into a large strip-shaped block, and then cutting the large strip-shaped block into louver curtain slats of desired dimensions. Another structure of a laminated bamboo louver curtain slat and its manufacture method, which is similar to the above-mentioned one, is disclosed in Chinese Utility Model No. 01258338.3. Main deficiencies of the methods consist in high machining cost, difficulty in machining and big materials waste, since, due to the difference in hardness and natures of bamboo, wood and adhesives, it is difficult to cut louver curtain slats directly from a massive block and it is not easy to cut uniformly; and meanwhile, conventional saw-cutting technique is still used and the thickness of the saw blade again causes a considerable volume of materials to be wasted. In addition, louver curtain slats of a single layer are monotony in processing property and lack of variation.

### SUMMARY OF THE INVENTION

An object of the invention is to eliminate the above-mentioned drawbacks of the prior art and to provide a bamboo-surfaced laminated louver curtain slat. A further object of the invention is to provide a manufacture method of the bamboo-surfaced laminated louver curtain slat.

The bamboo-surfaced laminated louver curtain slat according to the present invention comprises peeled bamboo veneer layers, said peeled bamboo veneer layer comprising two layers and at least one filler layer being sandwiched between the two peeled bamboo veneer layers. The peeled bamboo veneer layers and the filler layer(s) are bonded together in a glued manner.

As an improvement, said filler layer is made of at least one of the group consisting of wood sheet layer, synthetic paper layer, cloth layer or bamboo sheet layer.

As an improvement, the inside surface of said peeled bamboo veneer layer is affixed with a non-woven fabric liner.

As an improvement, said bamboo-surfaced laminated louver curtain slat has a curved cross section in a width direction.

As an improvement, said bamboo-surfaced laminated louver curtain slat has a curved cross section in a width direction of a S-, arched or a waved shape.

The invention provides a method of manufacturing the bamboo-surfaced laminated louver curtain slats, which comprises the following steps:

(1) selecting bamboo material which has been moth-proof, mould-proof and rot-proof pretreated and peeling it into peeled bamboo veneer layers;

(2) selecting filler material and processing it into filler layer sheets;

(3) laminating, hot-pressing and gluing a first peeled bamboo veneer layer, filler layer sheet(s), and a second peeled bamboo veneer layer in sequence in a thickness direction or in longitudinal and transversal directions with adhesives into a piece of ply-bamboo;

(4) cutting the ply-bamboo into semi-finished products of the bamboo-surfaced laminated louver curtain slats according to a predetermined length and width;

(5) finishing the semi-finished products of the bamboo-surfaced laminated louver curtain slats.

As an improvement, the method further comprises a step of press-forming the semi-finished products of the bamboo-surfaced laminated louver curtain slats in moulds.

As an improvement, the method further comprises a step of press-forming the semi-finished products of the bamboo-surfaced laminated louver curtain slats using metal moulds with upper and lower surfaces having parallel linear profiles.

As an improvement, the method further comprises a step of press-forming the semi-finished products of the bamboo-surfaced laminated louver curtain slats using metal moulds with upper and lower surfaces having corresponding curved profiles of a S-, arched or waved shape.

The invention further provides another method of manufacturing the bamboo-surfaced laminated louver curtain slat, which comprises the following steps:

(1) selecting bamboo veneer layers and cutting them according to a predetermined length and width;

(2) selecting filler material, processing it into filler layer sheets and then cutting the filler layer sheets according to a predetermined length and width;

(3) bonding and laminated a first bamboo veneer layer, filler layer sheet (s) and a second bamboo veneer layer obtained after cutting in sequence with adhesives and then press-forming them in moulds into a semi-finished product of a bamboo-surfaced laminated louver curtain slat;

(4) finishing said semi-finished product of the bamboo-surfaced laminated louver curtain slat.

As an improvement, said peeled bamboo veneer layers are made by the following steps:

(1) selecting bamboo material which has been moth-proof, mould-proof and rot-proof pretreated and processing it into bamboo sheets;

(2) bonding and laminating the bamboo sheets in longitudinal and transversal directions with adhesives into a piece of ply-bamboo;

(3) peeling the ply-bamboo into the peeled bamboo veneer layers.

As an improvement, said press-forming of the semi-finished slat product in the moulds is hot-pressing and gluing under a steam controlled temperature.

As an improvement, said press-forming of the semi-finished slat product in the moulds is press-forming using metal moulds with upper and lower surfaces having parallel linear profiles.

As an improvement, said press-forming of the semi-finished slat product in the moulds is press-forming using metal moulds with upper and lower surfaces having corresponding curved profiles of a S-, arched or waved shape.

As an improvement, in the two above-mentioned method of manufacturing the bamboo-surfaced laminated louver curtain slat, said filler material is at least one of the group consisting of wood sheet, synthetic paper, cloth or bamboo sheet which has been moth-proof, mould-proof and rot-proof pretreated.

As an improvement, in the two above-mentioned method of manufacturing the bamboo-surfaced laminated louver curtain slat, the method further comprises a step of drying the peeled bamboo veneer layers and the filler layer sheet(s) before they are laminated and bonded.

As an improvement, in the two above-mentioned method of manufacturing the bamboo-surfaced laminated louver curtain slat, the method further comprises a step of affixing a non-woven fabric liner to the inside surface of the peeled bamboo veneer layer before the layers are laminated and bonded.

As an improvement, in the two above-mentioned method of manufacturing the bamboo-surfaced laminated louver curtain slat, said step of finishing the semi-finished product of the bamboo-surfaced laminated louver curtain slat comprises sanding, chamfering or painting of the same.

In comparison to the prior art, profitable effects of the invention lie in:

1. with a manufacture method of laminating peeled bamboo sheets with a filler layer or layers sandwiched therebetween, bamboo materials of various sizes or even a small size can be used to manufacture peeled bamboo veneer layers, solving many difficulties in obtaining bamboo material; further, it is possible to use various rejected bamboo, wood or other materials as filler materials so as to make full use of the resource as much as possible; meanwhile, part of the performances of the bamboo material are adapted, so as to improve the deform-resistance of the bamboo louver curtain slats;

2. with a peeling process via cutting or planing to obtain bamboo veneer layers, the problem of material wastage during processing has be well addressed;

3. with curtain slats of desired size being glued and pressed directly in moulds, the manufacturing procedure is greatly simplified and louver curtain slats of various forms, such as those with a semi-circular or s-shaped curvature, can be directly press-formed as desired, which breaks through the monotony style of conventional louver curtain slats, make louver curtains novel and aesthetic and provide consumers with more choices, and which, at the same time, also improves effects of the louver curtains in anti-ultraviolet radiation and so on;

4. with a liner being affixed to the inside surface of the bamboo veneer layer and with the filler material being suitably selected, longitudinal and transversal toughness and strength of the louver curtain slat is enhanced and processing properties of the louver curtain are improved.

### DESCRIPTION OF THE DRAWINGS

Further features and characters will be apparent in the following detailed description of preferred embodiments with reference to the accompanying drawings in which:

FIG. 1 is a schematic view of the structure of a louver curtain slat according to a first embodiment;

FIG. 2 a schematic view of the structure of a louver curtain slat according to a second embodiment;

FIG. 3 is a schematic view of the structure of a mold according to the second embodiment;

FIG. 4 is a schematic view showing a situation in which the louver curtain slat according to the second embodiment is being press-formed;

FIG. 5 is a schematic view of the lamination structure of the louver curtain slat according to the second embodiment;

FIG. 6 is a schematic view of the structure of a mold according to a third embodiment;

FIG. 7 is a schematic view of the lamination structure of a louver curtain slat according to the third embodiment;

FIG. 8 is a schematic view of the structure of moulds according to a fourth embodiment; and

FIG. 9 is a schematic view of the lamination structure of a louver curtain slat according to the fourth embodiment.

### DETAILED DESCRIPTION OF EMBODIMENTS

The invention provide a brand new method of manufacturing a louver curtain slat. In this method, thin peeled bamboo veneer layers are peeled from a massive bamboo board made by gluing and pressing bamboo material. A first peeled bamboo veneer layer, filler material, and a second peeled bamboo veneer layer are glued and press-formed in sequence into a piece of ply-bamboo with a large width. Then, laminated louver curtain slats of a specified width are cut from the ply-bamboo. Alternatively, in said method, thin peeled bamboo veneer layers are peeled from a massive bamboo board and after being cut into a specified width, the peeled bamboo veneer layers, together with filler material, are put into moulds for hot-pressing and gluing into laminated louver curtain slats.

The invention differs from conventional method of manufacturing a louver curtain slat and it not only enlarges the range of useable raw bamboo material (since all kinds of bamboo material can be used to make a massive bamboo block by gluing and pressing), but also rationally utilizes certain waste bamboo, wood and so on as filler materials. Further, the process of peeling thin bamboo veneer is completely different from the conventional saw-cutting process. Such a peeling or planing process is to peel off bamboo veneers layer by layer from a massive bamboo block, which is simple and in which no raw material is wasted.

The invention is now described in detail by way of preferred embodiments in reference to the accompanying drawings.

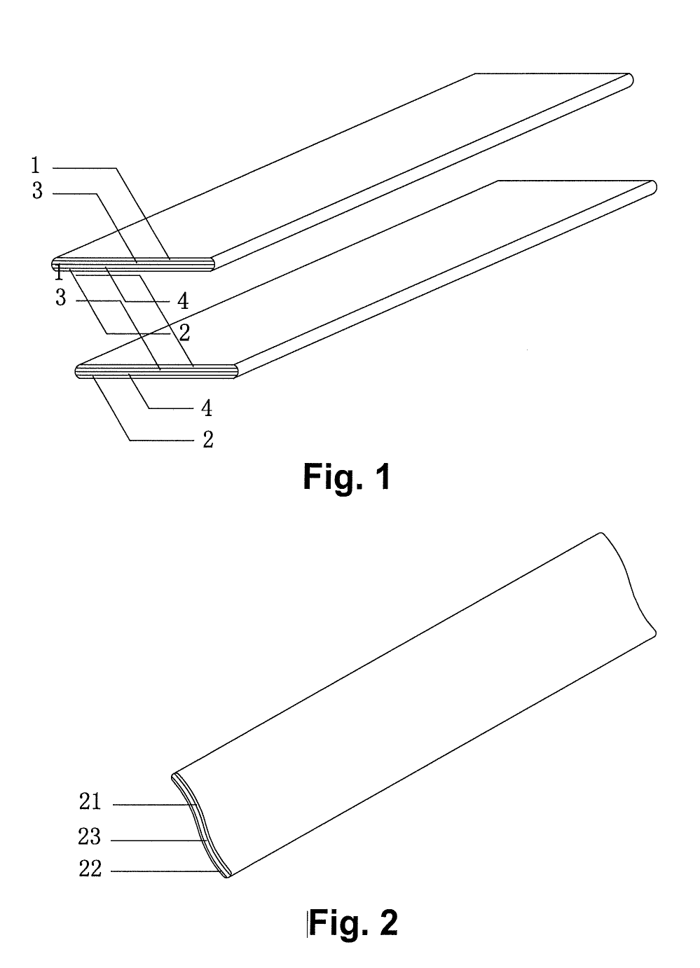

A bamboo-surfaced laminated louver curtain slat according to the first embodiment of the invention is shown in FIG. 1.

The slat is composed of totally of four layers. The outer two layers are a peeled bamboo veneer layer 1 and a peeled bamboo veneer layer 2, respectively, both of which have a thickness of 0.5 mm. The inner two layers are a filler layer 3 and a filler layer 4, respectively, both of which have a thickness of 0.5 mm. The filler layers are made of wood sheet layers. However, of course, they may also be made of synthetic paper layers, cloth layers or bamboo sheet layers as required by the process. The peeled bamboo veneer layer 1, the filler layer 3, the filler layer 4 and the peeled bamboo veneer layer 2 are sequentially bonded in a glued manner between every two adjacent layers and are laminated into a bamboo-surfaced laminated louver curtain slat of about 2.0 mm thickness. Non-woven fabric liners may be affixed to the inside surfaces of the peeled bamboo veneer layer 1 and the peeled bamboo veneer layer 2, so as to enhance longitudinal and transversal toughness and strength of the louver curtain slat and improve processing properties of the same.

The steps of manufacturing the bamboo-surfaced laminated louver curtain slat of the first embodiment are as follows:

(1) selecting bamboo material which has been moth-proof, mould-proof and rot-proof pretreated, severing it into sections of a certain length, and peeling the bamboo sections into bamboo veneer layers of 0.5 mm thickness by a bamboo veneer peeling machine;

(2) selecting wood material which has been moth-proof, mould-proof and rot-proof pretreated, severing it into sections of a certain length, and planing the wood sections into wood sheet layers, i.e. filler layer sheets, of 0.5 mm thickness;

(3) drying the peeling bamboo veneer layers and the filler layer sheets, and after they are dried to a required standard, laminating, hot-pressing and gluing a first peeled bamboo veneer layer, filler layer sheets (two wood sheet layers) and a second peeled bamboo veneer layer in sequence in a thickness direction or in longitudinal and transversal directions with adhesives into a piece of ply-bamboo having a thickness of 2.0 mm and a width of 1200×630-1050 mm;

(4) cutting the ply-bamboo into semi-finished products of bamboo-surfaced laminated louver curtain slats according to a predetermined length and width; and

(5) finishing the semi-finished products of the bamboo-surfaced laminated louver curtain slats, including the steps of sanding, chamfering and painting on both sides of the curtain slats.

In the process of manufacturing the ply-bamboo according the present embodiment, a non-woven fabric liner may be affixed to the inside surface of the peeled bamboo veneer layer prior to the lamination and bonding of the layers so as to enhance longitudinal and transversal toughness and strength of the louver curtain slat and improve processing properties of the louver curtain.

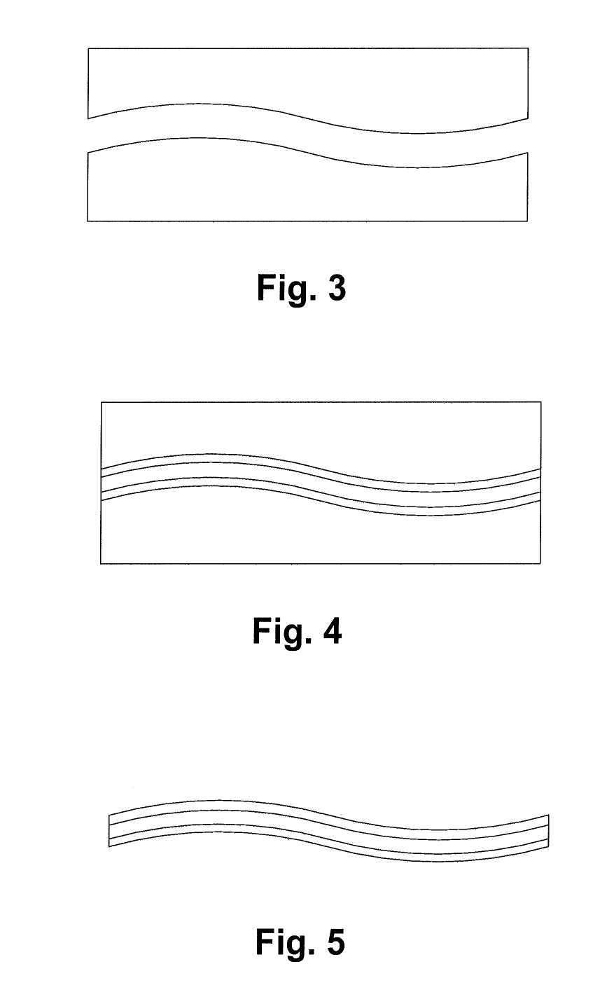

A bamboo-surfaced laminated louver curtain slat obtained by the method is shown in FIG. 1, the cross section of which in a width direction appears a linear bar shape. After the semi-finished slat products have been made through step (4), a further step may be added to adjust the appearance of the cross section in the width direction of the semi-finished slat product by mould pressing. For example, metal moulds with upper and lower surfaces having parallel linear profiles can be used to press-form the semi-finished product of the bamboo-surfaced laminated louver curtain slat, regulating any possible deformation after cutting of the curtain slat. Metal moulds with upper and lower surfaces having corresponding curved profiles of a S-, arched or waved shape can also be used to press-form the semi-finished product of the bamboo-surfaced laminated louver curtain slat so as to present diversity in appearance of curtain slats, break through the monotony style of conventional louver curtain slats, make louver curtains novel and aesthetic and provide consumers with more choices. Schematic views of the structures of metal moulds with upper and lower surfaces having corresponding curved profiles of a S-, arched or waved shape are shown in FIGS. 3, 6 and 8, and the cross-sectional appearances in the width direction of the louver slats after being regulated are shown in FIGS. 5, 7 and 9.

The resultant louver curtain slats are perforated and assembled together with strings and after pulleys and pull ropes are mounted thereon, they become a commercially available finished product of a bamboo surfaced laminated louver curtain.

A bamboo-surfaced laminated louver curtain slat according to the second embodiment of the invention is shown in FIG. 2.

The slat is composed of three layers. The outermost two layers are a peeled bamboo veneer layer 21 and a peeled bamboo veneer layer 22, respectively, both of which have a thickness of 0.4 mm. The intermediate layer is a filler layer 23 of 1.0 mm thickness. The filler sheet layer is made of wood sheet layer and, of course, it may also be made of a synthetic paper layer, cloth layer or bamboo sheet layer as required by the process. The peeled bamboo veneer layer 21, the filler layer 23, and the peeled bamboo veneer layer 22 are bonded in a glued manner between every two adjacent layers and are laminated into a bamboo-surfaced laminated louver curtain slat of about 1.8 mm thickness. Non-woven fabric liners may be affixed to the inside surfaces of the peeled bamboo veneer layers. This slat presents a curved cross section of S shape in the width direction. Of course, it can also be press-formed into a curved cross section of an arched or waved shape according to practical applications.

The steps of manufacturing the bamboo-surfaced laminated louver curtain slat of the second embodiment are as follows:

(1) selecting bamboo material that has been moth-proof, mould-proof and rot-proof pretreated, and processing it into bamboo sheets of a predetermined length and width;

(2) bonding and laminating the bamboo sheets in longitudinal and transverse directions with adhesives into a piece of ply-bamboo;

(3) peeling the ply-bamboo into peeled bamboo veneer layers of 0.4 mm thickness;

(4) selecting peeled bamboo veneer layers and cutting them according to a predetermined length and width of a curtain slat;

(5) selecting wood material which has been moth-proof, mould-proof and rot-proof pretreated, severing them into sections of a certain length, planing the wood sections into wood sheet layers of 1.0 mm thickness, i.e. the filler sheets, and then cutting the wood sheet layers according to a predetermined length and width of the louver curtain slat;

(6) bonding and laminated a first bamboo veneer layer, a filler layer sheet and a second bamboo veneer layer in sequence with adhesives, putting them into metal moulds with upper and lower forming surfaces having corresponding curved profiles of a S shape (see FIG. 3), hot-pressing and gluing them for about 5 seconds while the temperature is controlled at 100° C. by means of steam, and then removing them to let them cool naturally so as to obtain a semi-finished slat product (the press process is shown in FIG. 4 and the lamination structure of the resultant curtain slat is shown in FIG. 5); the bamboo veneer layers and filler layer sheet can be dried once more before they are laminated and bonded;

(7) finishing the semi-finished slat product, including the steps of sanding, chamfering and painting on both sides of the curtain slats.

The resultant curtain slats are perforated and assembled together with strings, and after pulleys and pull rope are mounted thereon, they become a commercially available finished product of a bamboo surfaced laminated louver curtain.

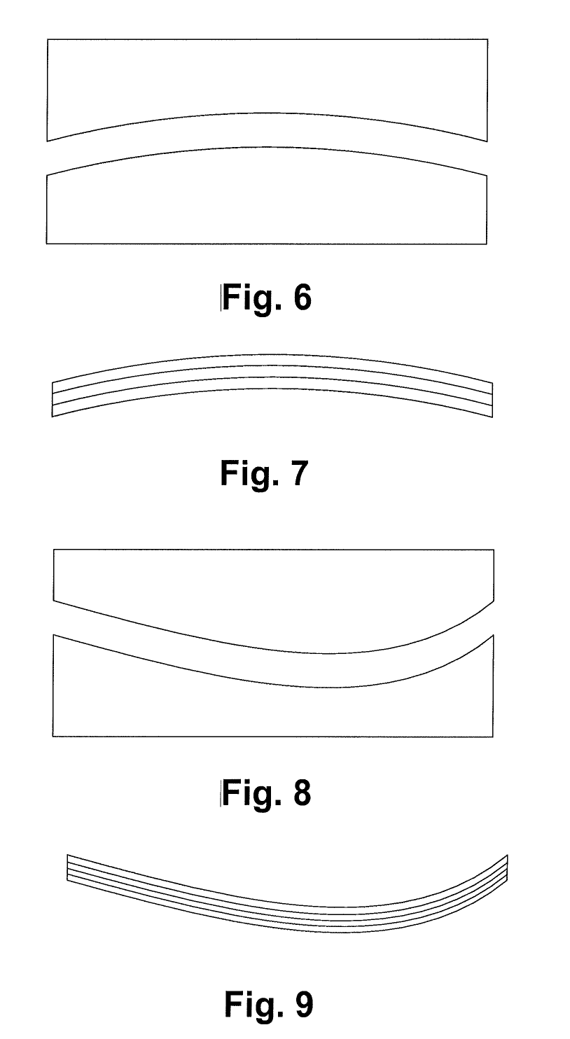

The method of manufacturing a bamboo-surfaced laminated louver curtain slat of the third embodiment of the invention is the same as that of the second embodiment. In the third embodiment, the metal press molds have upper and lower surfaces with corresponding curved profiles of an arched shape with a relatively large curvature (see FIG. 6). Non-woven fabric liners are further affixed to the inside surfaces of the two peeled bamboo veneer layers before they are hot-pressed and bonded by the metal moulds. The filler layers is made of synthetic paper. The lamination structure of the resultant curtain slat is shown in FIG. 7.

The method of manufacturing a bamboo-surfaced laminated louver curtain slat of the fourth embodiment of the invention is the same as that of the second embodiment. In the fourth embodiment, the metal press molds have upper and lower surfaces with corresponding curved profiles of a L-shaped waved form (see FIG. 8). Non-woven fabric liners may be affixed to the inside surfaces of the two peeled bamboo veneer layers before they are hot-pressed and bonded. The filler layer is made of cloth. The lamination structure of the resultant curtain slat is shown in FIG. 9.

It is to be noted that the louver curtain slat can be made into any length, width and thickness according to practical applications. The filler layer(s) can be made of bamboo, wood, paper, cloth and so on and can be one, two or more layer(s), and these materials may be used alone or in combination. The adhesives selected should meet the requirements of having a sufficient binding strength, being environment friendly and so on. The profiles of the moulds may be determined according to requirement of users, so as to make the louver curtain slats have more styles.

### INDUSTRIAL APPLICABILITY

In comparison to the prior art, profitable effects of the invention lie in:

1. with a manufacture method of laminating peeled bamboo sheets with a filler layer or layers sandwiched therebetween, bamboo materials of various sizes or even a small size can be used to manufacture peeled bamboo veneer layers, solving many difficulties in obtaining bamboo material; further, it is possible to use various rejected bamboo, wood or other materials as filler materials so as to make full use of the resource as much as possible; meanwhile, part of the performances of the bamboo material are adapted, so as to improve the deform-resistance of the bamboo louver curtain slats;

2. with a peeling process via cutting or planing to obtain bamboo veneer layers, the problem of material wastage during processing has be well addressed;

3. with curtain slats of desired size being glued and pressed directly in moulds, the manufacturing procedures is greatly simplified and louver curtain slats of various forms, such as those with a semi-circular or s-shaped curvature, can be directly press-formed as desired, which breaks through the monotony style of conventional louver curtain slats, make louver curtains novel and aesthetic and provide consumers with more choices, and which, at the same time, also improves effects of the louver curtains in anti-ultraviolet radiation and so on;

4. with a liner being affixed to the inside surface of the bamboo veneer layer and with the filler material being suitably selected, longitudinal and transversal toughness and strength of the louver curtain slat is enhanced and processing properties of the louver curtain are improved.

1-5. (canceled)

6. A method of manufacturing bamboo-surfaced laminated louver curtain slats comprising two peeled bamboo veneer layers and at least one filler layer sandwiched between the two peeled bamboo veneer layers, wherein the peeled bamboo veneer layers and the filler layer are bonded together in a glued manner, the method comprising the following steps:
(1) selecting bamboo material which has been moth-proof, mould-proof and rot-proof pretreated and peeling it into peeled bamboo veneer layers;
(2) selecting filler material and processing it into filler layer sheets;
(3) laminating, hot-pressing and gluing a first peeled bamboo veneer layer, filler layer sheet(s), and a second peeled bamboo veneer layer in sequence in a thickness direction or in longitudinal and transversal directions with adhesives into a piece of ply-bamboo;
(4) cutting the ply-bamboo into semi-finished products of the bamboo-surfaced laminated louver curtain slats according to a predetermined length and width;
(5) finishing the semi-finished products of the bamboo-surfaced laminated louver curtain slats.

7. The method of manufacturing bamboo-surfaced laminated louver curtain slats according to claim 6, characterized in that it further comprises a step of press-forming the semi-finished products of the bamboo-surfaced laminated louver curtain slats in moulds.

8. The method of manufacturing bamboo-surfaced laminated louver curtain slats according to claim 6, characterized in that it further comprises a step of press-forming the semi-finished products of the bamboo-surfaced laminated louver curtain slats using metal moulds with upper and lower surfaces having parallel linear profiles.

9. The method of manufacturing bamboo-surfaced laminated louver curtain slats according to claim 6, characterized in that it further comprises a step of press-forming the semi-finished products of the bamboo-surfaced laminated louver curtain slats using metal moulds with upper and lower surfaces having corresponding curved profiles of a S-, arched or waved shape.

10. The method of manufacturing bamboo-surfaced laminated louver curtain slats according to claim 6, characterized in that said filler material is at least one of the group consisting of wood sheet, synthetic paper, cloth and bamboo sheet which has been moth-proof, mould-proof and rot-proof pretreated.

11. The method of manufacturing bamboo-surfaced laminated louver curtain slats according to claim 6, characterized in that it further comprises a step of drying the peeled bamboo veneer layers and the filler layer sheet(s) before they are laminated and bonded.

12. The method of manufacturing bamboo-surfaced laminated louver curtain slats according to claim 6, characterized in that it further comprises a step of affixing a non-woven fabric liner to the inside surface of the peeled bamboo veneer layer before the layers are laminated and bonded.

13. The method of manufacturing bamboo-surfaced laminated louver curtain slats according to claim 6, characterized in that said step of finishing the semi-finished products of the bamboo-surfaced laminated louver curtain slats comprises sanding, chamfering or painting of the same.

14. A method of manufacturing bamboo-surfaced laminated louver curtain slats comprising two peeled bamboo veneer layers and at least one filler layer sandwiched between the two peeled bamboo veneer layers, wherein the peeled bamboo veneer layers and the filler layer are bonded together in a glued manner, the method comprising the following steps:
(1) selecting peeled bamboo veneer layers and cutting them according to a predetermined length and width;
(2) selecting filler material, processing it into filler layer sheets and then cutting the filler layer sheets according to a predetermined length and width;
(3) bonding and laminated a first peeled bamboo veneer layer, filler layer sheet (s) and a second peeled bamboo veneer layer obtained after cutting in sequence with adhesives and then press-forming them in moulds into a semi-finished product of a bamboo-surfaced laminated louver curtain slat;
(4) finishing said semi-finished product of the bamboo-surfaced laminated louver curtain slat.

15. The method of manufacturing bamboo-surfaced laminated louver curtain slats according to claim 14, characterized in that said peeled bamboo veneer layers are made by the following steps:
(1) selecting bamboo material which has been moth-proof, mould-proof and rot-proof pretreated and processing it into bamboo sheets;
(2) bonding and laminating the bamboo sheets in longitudinal and transversal directions with adhesives into a piece of ply-bamboo;
(3) peeling the ply-bamboo into the peeled bamboo veneer layers.

16. The method of manufacturing bamboo-surfaced laminated louver curtain slats according to claim 14, characterized in that said press-forming of the semi-finished slat product in the moulds is hot-pressing and gluing under a steam controlled temperature.

17. The method of manufacturing bamboo-surfaced laminated louver curtain slats according to claim 14, characterized in that said press-forming of the semi-finished slat product in the moulds is press-forming using metal moulds with upper and lower surfaces having parallel linear profiles.

18. The method of manufacturing a bamboo-surfaced laminated louver curtain slat according to claim 14, characterized in that said press-forming of the semi-finished slat product in the moulds is press-forming using metal moulds with upper and lower surfaces having corresponding curved profiles of a S-, arched or waved shape.

19. The method of manufacturing a bamboo-surfaced laminated louver curtain slat according to claim 14, characterized in that said filler material is at least one of the group consisting of wood sheet, synthetic paper, cloth or bamboo sheet which has been moth-proof, mould-proof and rot-proof pretreated.

20. The method of manufacturing a bamboo-surfaced laminated louver curtain slat according to claim 14, characterized in that it further comprises a step of drying the peeled bamboo veneer layers and the filler layer sheet(s) before they are laminated and bonded.

21. The method of manufacturing a bamboo-surfaced laminated louver curtain slat according to claim 14, characterized in that it further comprises a step of affixing a non-woven fabric liner to the inside surface of said peeled bamboo veneer layer before the layers are laminated and bonded.

22. The method of manufacturing a bamboo-surfaced laminated louver curtain slat according to claim 14, characterized in that said step of finishing the semi-finished product of the bamboo-surfaced laminated louver curtain slat comprises sanding, chamfering or painting of the same.
